(19) United States
(12) Patent Application Publication
(10) Pub. No.: US 2013/0097939 A1
(43) Pub. Date: Apr. 25, 2013

(54) Overlay Panel System for an Overhead Garage Door and Method of Installation

(71) Applicant: Charles C. Blume, Euless, TX (US)

(72) Inventor: Charles C. Blume, Euless, TX (US)

(21) Appl. No.: 13/279,463

(22) Filed: Oct. 24, 2011

(51) Int. Cl. E06B 5/00

(52) U.S. Cl. 49/506

(57) ABSTRACT

A method for constructing a horizontal section of an overhead garage door begins by providing a previously manufactured metal door section. A sheet of moldable material is shaped by heating and vacuum forming in order to produce a decorative overlay panel. The overlay panel has a front exposed surface which forms a front face for the door section of the garage door when overlaid on the door section. The overlay panel is mounted on the horizontal door section to provide a decorative appearance to the door section. A number of the door sections so overlaid are assembled to produce the resulting hinged overhead garage door.

### BACKGROUND OF THE INVENTION

A. Field of the Invention:

This present invention relates to an overhead garage door that presents a decorative facade with an appearance which simulates authentic wood grain or other esthetic designs which are complimentary to the style of the associated residential or commercial structure containing the door.

B. Description of the Prior Art

Historically, garage door designs were likely taken from barn doors. Thus, garage doors originally had either two door members which were hinged at the sides of the garage entry opening, or a single door member which could be spring or counterbalance lifted into the ceiling of the garage. As these designs were impractical for many applications, a sectional garage door was the next major innovation in the development of the garage doors.

Modern sectional garage door systems are typically comprised of doors having horizontally arrayed sections joined by hinges into a door unit. The door is mounted in a vertical track which curves upwardly into a horizontal position so that the door may be opened upwardly and supported horizontally in an open position. The sections are joined by the hinges along the longitudinal edges of the sections so that the overall door structure will generally conform to the radius of curvature of the track as it changes from vertical to horizontal. Customarily, each of the sections are fabricated separately and thereafter hinged together along a longitudinal edge to provide the complete overhead door structure.

The original panel sections for sectional doors were manufactured of wood. Up until about the mid 1960's, wood sectional doors dominated the marketplace. There are two general types of wood panel sections, those of a raised or recessed design and those of a flush design. Both designs of wood sectional doors include disadvantages which are inherent to the properties associated with wood. For example, wood has the tendency to split, crack, splinter, rot and warp, because it is sensitive to temperature and humidity changes, water absorption and sunlight. Wood panel sections are also typically heavier than many other types of panel sections, creating more stress on the connecting hardware, making it more difficult to manually raise and lower the garage door, and costing more money to raise and lower the garage door by an electrical opener. Additionally, wood panel sections frequently require continuous painting or staining to maintain their desired appearance.

As a result of the above disadvantages associated with wood doors, the next technological advancement was the advent of the steel or metal sectional door. At the present time, steel sectional doors have replaced the wood market with near domination in the current marketplace. Despite offering many advantages over wood doors, the steel door section may be somewhat plainer or lacking in certain esthetic aspects. As a result, in addition to the steel sectional garage doors, specialty sectional garage doors have been introduced which make use of aluminum, plastic, and/or fiberglass. Some of these doors have the basic steel sections with the sections being overlaid with some type of “cladding” or laminate layer. While offering additional esthetic details such as a wood grain appearance, the appearance of transparent glass, etc., these systems continue to have some undesirable attributes. They tend to be heavy, increasing the overall weight of the door, and more expensive in many cases than the esthetic improvement warrants.

Thus, despite the advances which have been made in the relevant arts, a need continues to exist for a panel overlay or decorative facade for a section of a steel overhead garage door.

A need exists for such a panel which simulates the real grain and appearance of a wood door without adding significantly to the overall weight of the panel.

A need exists for such a panel for an overhead garage door which, in addition to being light weight, is inexpensive to manufacture and can easily and inexpensively be attached to an existing garage door section during the manufacture of the garage door.

### SUMMARY OF THE INVENTION

In view of the foregoing, it would be an advancement in the art to provide an overhead garage door with a decorative overlay panel system which would improve the esthetic appearance of the garage door, including providing the same with an authentic wood grain appearance. Such a novel garage door and method of manufacturing the same are disclosed and claimed herein.

The improved manufacturing method of the invention is used for constructing a horizontal section of an overhead garage door having a front face provided with a decorative facade, a rear face and a peripheral edge. In the first step in the method, a plurality of previously manufactured metal door sections are assembled. Next, a sheet of moldable material is shaped by heating and vacuum forming in a thermoforming process in order to produce a decorative overlay panel having a thickness in the range from about 1/32 to ⅛ inches. The overlay panel has a front exposed surface which defines a front face for the door section of the garage door when overlaid on the door section, a rear face, and a peripheral surface defining at least in part the peripheral edge of the door. A decorative overlay panel is fixedly mounted onto the front face of a plurality of the garage door sections. The so manufactured door sections are then hingedly mounted to one another to create the resulting hinged overhead garage door.

The preferred class of moldable materials used in the process are moldable thermoplastic materials, particularly such materials which are suitable for use in a thermoforming manufacturing process. Suitable candidate materials can conveniently be selected from among the general classes of acrylonitrile butadiene styrene, high impact polystyrene, acrylonitrile styrene acrylate, acrylics, co-polyesters, polycarbonates and polyvinylchloride.

The mounting step for mounting the decorative overlay panel to the metal door section can also include the step of gluing the rear face of the decorative overlay panel to the front face of the garage door section. If desired, the method can also include the additional step of applying a high performance coating to the decorative overlay panel which is effective to increase U.V. resistance of the exposed face of the overlay panel.

The thermoforming process comprises a series of vacuum forming steps comprises the steps of:

supporting the sheet of moldable material over a mold;
heating the sheet to a temperature at which said moldable material can be reshaped; and
establishing a vacuum between the sheet and the mold, the vacuum pulling in the heated sheet to the mold where this sheet hardens to a desired shape to form the decorative overlay panel.

The mold can be formed from wood having an exposed top surface with a wood grain texture, whereby pulling the heated sheet onto the exposed top surface of the mold causes the heated sheet to acquire a real wood grain appearance.

Additional objects, features and advantages will be apparent in the written description which follows.

### BRIEF DESCRIPTION OF THE DRAWINGS

FIG. 1 is a perspective view of a traditional overhead garage door of the prior art, having a plurality of horizontal steel sections.

FIG. 2 is a view of an overhead garage door of the invention, similar to FIG. 1, but showing the wood grain appearance of the overlay panels of the invention.

FIGS. 3A-3G are simplified, schematic representations of the steps in the thermoforming process used to produce the overlay panels of the invention.

FIG. 4 is a front plan view of a garage door of the invention having a plurality of the overlay panels of the invention installed on the door.

FIG. 5 is a side view, taken along lines V-V in FIG. 4.

FIG. 6 is a top view, taken along lines VI-VI in FIG. 4.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

As discussed briefly above, commercially available garage doors used at the present time are typically assembled from a series of door sections aligned horizontally in an edge-to-edge configuration to form a vertically oriented door for the garage opening. The sections are hinged together as a series along their abutting, horizontal edges to allow the garage door to be raised upwardly in a track to an overhead, horizontal position. The track includes a curved section between the vertical and the overhead positions. The hinged sections allow the garage door to traverse this curved section during the transition of the garage door from the vertical to the overhead, horizontal position.

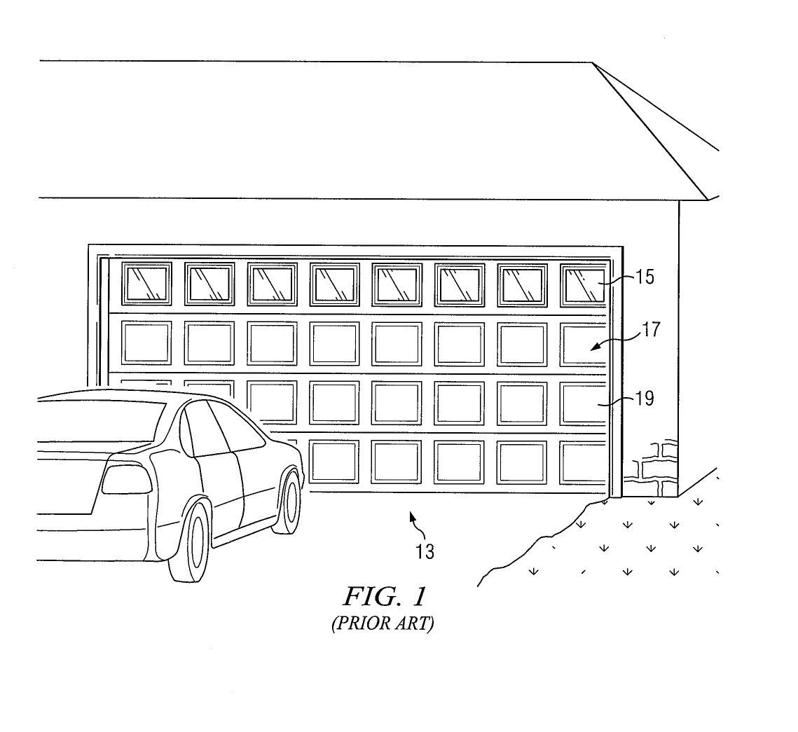

In many of the presently available garage door systems, a series of decorative windows are incorporated the garage door, typically within an upper section of the garage door. These windows are formed in individual panels of the upper section and provide daylight illumination of the closed garage as well as a decorative appearance. A window opening is formed in each panel. Applicant's FIG. 1 shows a typical garage door 13 having window assemblies 15 installed into openings provided in a top section thereof. The horizontal sections which are connected by hinges are shown, for example, as 17 and 19 in FIG. 1. While the typical garage door shown in FIG. 1 is widely popular at the present time and adequately serves the purpose of enclosing the garage space, many homeowners desire a garage door with more esthetic detail in the exposed front surface, for example, an authentic wood grain appearance.

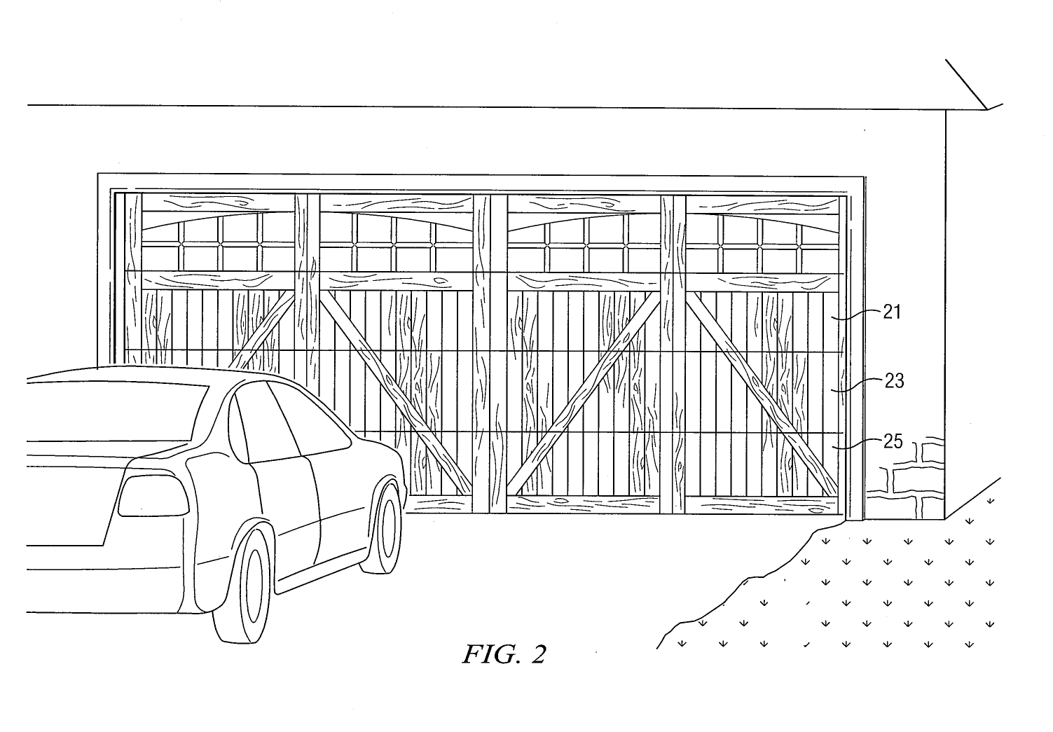

FIG. 2 shows an overhead garage door of the invention provided with the overlay panels (21, 23 and 25 in FIG. 2) of the invention which give the exposed front face of the garage door the appearance of real wood. The underlying hinged steel door sections are located beneath the overlay panels.

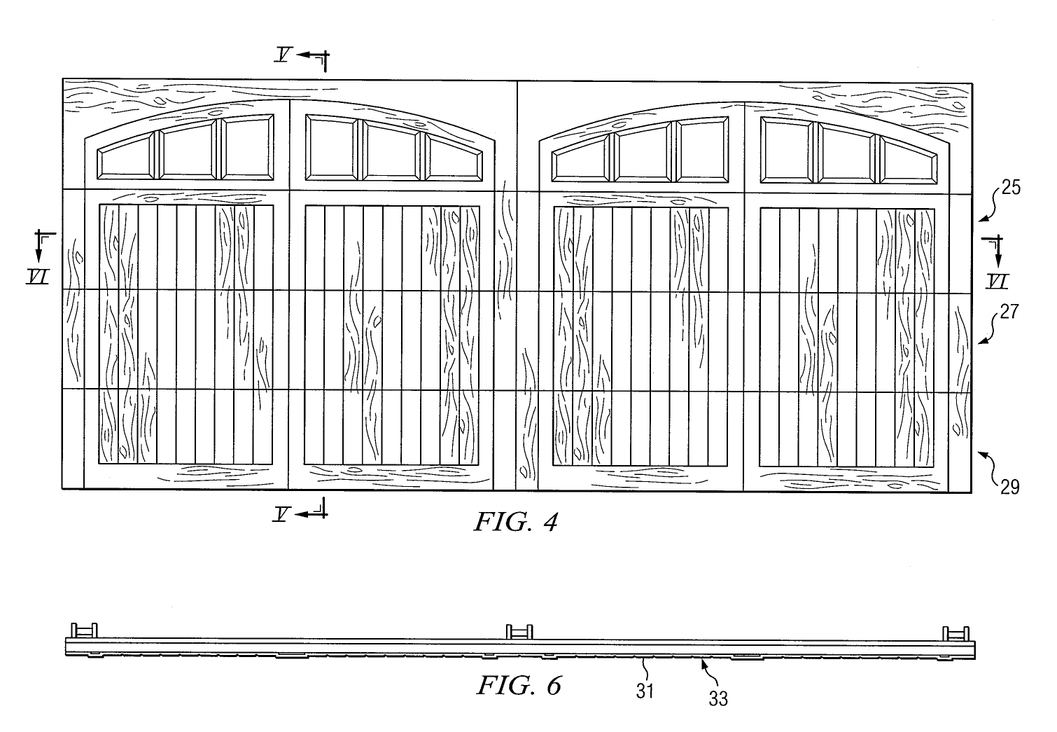

The method of the invention is thus used to construct a horizontal section of an overhead garage door, such as the sections 25, 27 and 29 in FIG. 4. While the particular sections shown in FIG. 4 give the garage door a wood grain “carriage house” appearance, it will be apparent that any number of decorative effects might be achieved using the manufacturing process which is to be described. The technique is used to provide a horizontal section having a front face (31 in FIGS. 5 and 6) provided with a decorative facade in the form of an overlay panel 33. The horizontal sections also have a rear face 35 and a peripheral edge 37, as can be seen in FIG. 5. Note that the thickness of the overlay panel 33 shown in FIGS. 5 and 6 is somewhat exaggerated in thickness for ease of illustration. The preferred thickness will be in the range from about 1/32 to about ⅛ inches, for example 1/16 inch.

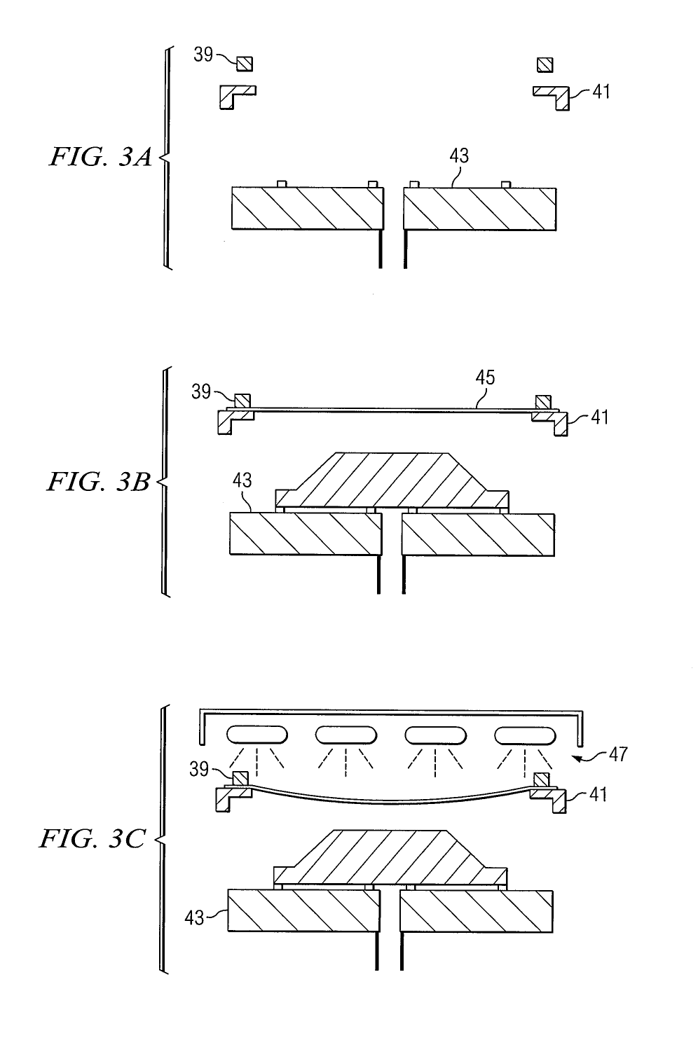

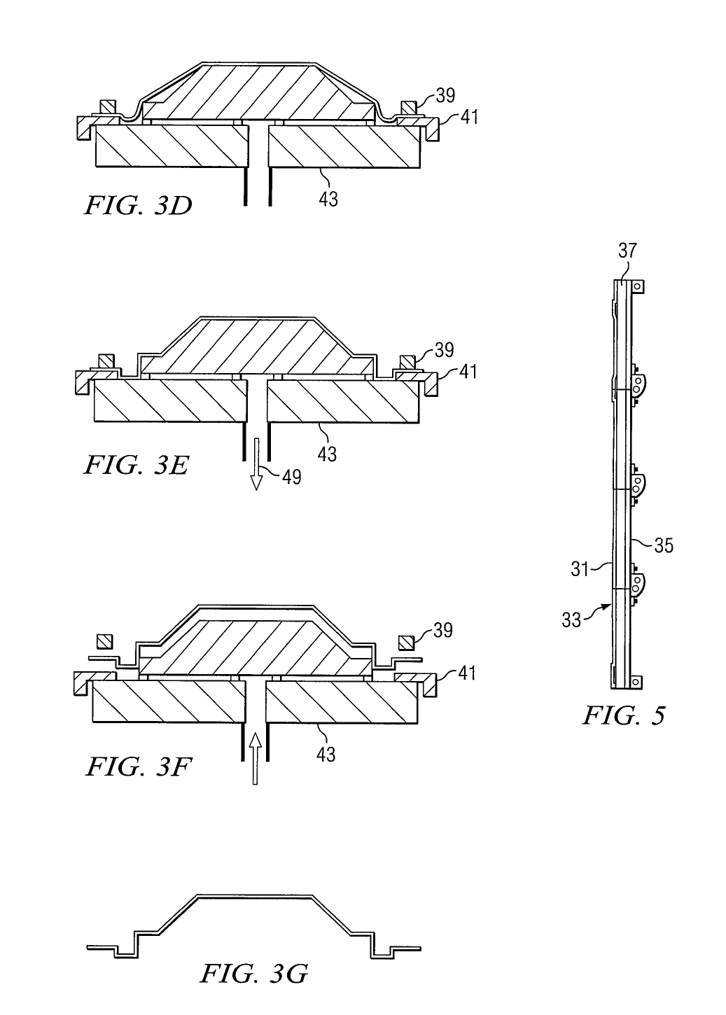

FIGS. 3A-3G are a schematic illustration of the steps involved in thermoforming one of the overlay panels which is used in the method of the present invention. In the most basic terms, the overlay panel is shaped by vacuum thermoforming to provide the corresponding face of the door with a decorative pattern, such as a real wood grain appearance. In the vacuum thermoforming process, a sheet of the moldable material is supported over a mold and is heated to a temperature at which it can be reshaped. This mold is provided with means permitting it to establish a vacuum between the moldable sheet of material and the mold that will pull in the softened sheet to the mold contour where it hardens to the desired shape.

The process starts with a flat sheet of a moldable material which is suitable for use in a thermoforming process. Plastics comprise a wide range of materials but fundamentally fall into two basic classes, thermoset and thermoplastic. The thermoplastic materials have the property of softening repeatedly when heated and hardening when cooled. Thermoplastics also have what is known as a “memory” enabling a formed part to revert to its original state when reheated. It is the thermoplastic type of material which is specifically preferred for the thermoforming process.

Thermoplastics are generally divided into two subclasses, amorphous and crystalline. Crystalline thermoplastics contain an ordered manner of molecules and amorphous thermoplastics contain a random arrangement. Generally speaking, amorphous materials, such as polystyrene and acrylonitrile butadiene styrene (ABS) are easier to vacuum form, as they do not have such a critical forming temperature. Semi-crystalline and crystalline materials, such as polyethylene and polypropylene, have a far more critical forming temperature.

With the above factors in mind, some of the more commonly used amorphous and semi-crystalline materials used in the vacuum thermoforming process include such moldable materials as acrylonitrile butadiene styrene (ABS). This material is a hard, rigid amorphous thermoplastic with good impact strength and weather resistance. It contains a rubber content which gives it an improved impact resistance.

Another class of materials are the acrylics, i.e., polymethylmethacrylate, sold as PLEXIGLASS. This is a hard amorphous plastic with good clarity which can be worked somewhat after forming. However, it tends to be more brittle and is somewhat temperature sensitive.

Also to be considered are the co-polyesters such as polyethylene terepthalate, or PETG. This is an easily formed thermoplastic utilizing low temperatures and fast cycle times.

Another class of materials are the polystyrene materials such as so called high impact polystyrene. This is another easily formed thermoplastic material which is widely used in the thermoforming arts.

It is available with different textures and patterns and forms easily at low temperatures and fast cycle times.

Another class of materials are the polycarbonates such as LEXAN. These are hard, rigid and clear amorphous materials with relatively high impact resistance. However, they require a higher forming temperature.

Among the semi-crystalline materials are the polyolefins such as polypropylene (PP) and polyethylene (PE, HDPE, LDPE). These materials have more difficult forming characteristics due to the semi-crystalline nature of the base stock.

Another class of material is polyvinylchloride (PVC). This class of materials tends to be strong and tough with good chemical and fire retardant properties.

The following list gives some of the acceptable candidate materials by customary trade name, including some composite or “layered” materials:

Weatherable Polymer over ABS
Weatherable ABS over ABS
Acrylic Film over ABS
Korad™ Film over ABS
Acrylic Film over HIPS or SHIPS (Super High Impact Polystyrene)
PMMA over ABS (PMMA=any form of Acrylic-General Purpose, Impact Modified, etc.)
PMMA over HIPS or SHIPS

### HIPS

### SHIPS

### ABS

### TPO (Thermoplastic Olefin)

Acrylic Film over TPO
Korad™ Film over TPO

One preferred material for the thermoforming process of the invention is a general purpose ABS. Typical characteristic data for such materials are as follows:

| Test: | Condition | Value | |
|---|---|---|---|
| Specific Gravity | ASTM D792 | 1.04 | g/cm3 |
| Tensile Modulus | ASTM D638 | 310,000 | psi |
| Tensile Strength | ASTM D638 | 6,000 | psi |
| Flexural Modulus | ASTM D790 | 340,000 | psi |
| Flexural Strength | ASTM D790 | 10,000 | psi |
| Izod Impact | ASTM D256 | 7.5 | ft-lbs/in |
| Heat Deflection Temp | ASTM D648 | 198 | degrees F. |
| Hardness | ASTM D785 | 105 | Rockwell |

Returning now to FIGS. 3A-3G, a sheet of ABS as previously described is placed in a thermoforming oven (FIG. 3A) having a clamp frame 39, a machine frame 41 and a rise and fall table 43. FIG. 3B shows the plastic sheet 45 clamped into place and with a mold in place on the rise and fall table. FIG. 3C shows the oven heaters 47 brought forward, causing the plastic sheet 45 to soften. In FIG. 3D, the table is raised and locked whereby the softened plastic sheet 45 is stretched over the mold. In FIG. 3E, air is evacuated through a port region 49, whereby the plastic sheet is sucked into the mold. In FIG. 3F, the plastic sheet 45 has cooled and air is blown back into the mold region to push the thermoformed sheet back off the mold. FIG. 3G shows the formed part after is has been removed from the mold. The decorative overlay panel so produced preferable has a thickness in the range from about 1/32 to about ⅛ inches, for example, 1/16 inch.

The thermoformed plastic sheet is then attached to the front face (31 in FIGS. 5 and 6) of the garage door section. The overlay panel has a front exposed surface which defines a front face for the door section of the garage door when overlaid on the door section, a rear face, and a peripheral surface defining at least in part the peripheral edge of the door. The decorative overlay panel can be attached or mounted on the metal door section, as by gluing the rear face of the decorative overlay panel to the front face of the garage door section. It may also be convenient in some cases to tack, nail or screw the overlay panel to the door section to temporarily hold the overlay in place while the glue dries between the panel and the door section. A plurality of such overlaid door sections can then be hingedly mounted, one to another, to create the resulting hinged overhead garage door.

If desired, the previously described manufacturing process may also include the optional step of applying a high performance coating to the decorative overlay panel which is effective to increase U.V. resistance of the exposed face of the overlay panel.

While the mold used to form the decorative overlay panel of the invention may take a number of different forms, the mold can conveniently be formed from wood having an exposed top surface with a wood grain texture, whereby pulling the heated sheet onto the exposed top surface of the mold causes the heated sheet to acquire a real wood grain appearance. In other cases, alternative materials such as aluminum or Masonite might be used to form the mold.

An invention has been provided with several advantages. The decorative overlay panels of the invention can be used to construct an overhead garage door section which has a decorative appearance which improves the esthetic appeal of the complete door. The thermoforming method used to produce the overlays is relatively simple to carry out using a variety of commonly available stock materials. The resulting overlay panels are light weight and relatively durable. They can be provided in a variety of colors and textures or finishes including an authentic wood grain appearance. The panels can be easily attached to the front exposed face of an existing metal garage door section.

While the invention has been shown in one of its forms, it is not thus limited and is susceptible to various changes and modifications without departing from the spirit thereof.

What is claimed is:

1. A method for constructing a horizontal section of an overhead garage door having a front face provided with a decorative facade, a rear face and a peripheral edge, the method comprising the steps of:
providing a previously manufactured metal door section;
shaping a sheet of moldable material by heating and vacuum forming in order to produce a decorative overlay panel having a thickness in the range from about 1/32 to ⅛ inches, the overlay panel having a front exposed surface which defines a front face for the door section of the garage door when overlaid on the door section, a rear face, and a peripheral surface defining at least in part the peripheral edge of the door;
fixedly mounting the decorative overlay panel onto the front face of the garage door section; and
hingedly mounting a plurality of such overlaid door sections one to another to create the resulting hinged overhead garage door.

2. The method of claim 1, wherein the moldable material is a thermoplastic material.

3. The method of claim 1, wherein the moldable material is selected from the group consisting of acrylonitrile butadiene styrene, high impact polystyrene, acrylonitrile styrene acrylate, acrylics, co-polyesters, polycarbonates and polyvinylchloride.

4. The method of claim 1, wherein the mounting steps include the step of gluing the rear face of the decorative overlay panel to the front face of the garage door section.

5. The method of claim 4, including the additional step of applying a high performance coating to the decorative overlay panel which is effective to increase U.V. resistance of the exposed face of the overlay panel.

6. The method of claim 1, wherein the vacuum forming step comprises the steps of:
supporting the sheet of moldable material over a mold;
heating the sheet to a temperature at which said moldable material can be reshaped; and
establishing a vacuum between the sheet and the mold, the vacuum pulling in the heated sheet to the mold where this sheet hardens to a desired shape to form the decorative overlay panel.

7. The method of claim 6, wherein the mold is formed from wood having an exposed top surface with a wood grain texture, whereby pulling the heated sheet onto the exposed top surface of the mold causes the heated sheet to acquire a real wood grain appearance.
